(19) United States
(12) Patent Application Publication
(10) Pub. No.: US 2009/0255066 A1
(43) Pub. Date: Oct. 15, 2009

(54) REARRANGEABLE INTERCONNECTABLE SYSTEM FOR HANDICAP RAMPS AND PLATFORMS

(76) Inventor: Robert D. Brock, Grand Haven, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/420,507

(22) Filed: Apr. 8, 2009

Related U.S. Application Data
(60) Provisional application No. 61/044,188, filed on Apr. 11, 2008.

(51) Int. Cl. E04F 11/00; B65G 69/28; E01D 15/133; E04H 3/24; E04H 3/28

(52) U.S. Cl. 14/69.5; 52/7

(57) ABSTRACT

A series of interconnectable foam-block ramps and platforms are provided that are cut from low density EPS foam but coated with durable exterior polyurea coating, and that include optional hard surfaces, and edge-and-corner treatments, and railing with hand grips. The components resist deformation and withstand extreme weather conditions, but are surprisingly lightweight and include integral hook connectors that securely engage. They can be easily assembled/installed to form a handicap ramp and/or arranged to form novel “terrains” for wheeled devices and/or arranged to form stages and platforms. The components are sufficiently durable to support high-stress wheeled devices such as a wheelchairs, trick bikes, skateboards, in-line skates and the like. A variety of optional components include a curb-simulating element, intersection-forming platforms, X-intersection connectors, double-decker platforms, steps, and railings.

This application claims priority under 35 U.S.C. §119(e) of provisional application Ser. No. 61/044,188, filed Apr. 11, 2008, entitled REARRANGEABLE INTERCONNECTABLE RAMPS AND PLATFORMS, the entire contents of which are incorporated herein in their entirety.

### BACKGROUND

The present invention relates to rearrangeable ramps and platforms that can be used in a number of ways, such as for handicap ramps, and/or that can be used to create terrains and ramp arrangements for fun and other physical activities by bikers, skateboarders, in-line skaters, and other wheeled devices, and/or that can be used as stages and platforms for bands, choirs, theatrical performances, and other performers.

Ramps are often needed by handicapped individuals for access to buildings, including commercial and residential buildings. This includes both permanent ramps such as for commercial buildings, and semi-permanent or temporary ramps such as for homes and semi-private constructions. However, ramps are often expensive, surprisingly complex, time-consuming to build, and sometimes unsightly. Further, there are numerous local, state, and federal regulations and safety requirements that must be met. As a result of the above, handicap ramps are often never built, . . . or there is an attempt simply try to get by without one, even though one may be highly desirable.

Athletes and people using recreational wheeled devices such as in-line skates, skateboards, and multi-wheel cycles desire different terrains to challenge themselves physically and to make their endeavors more interesting. However, it is expensive to construct terrains suitable for such activities, and further such constructions cannot be easily rearranged. Many known “terrain-forming structures” (including constructions that can be assembled to make curves and slopes such as for skateboarders and the like) are made in part from cement, wood and/or metal, all of which are heavy. This is based on their availability, their relatively lower cost and the assumption that weight is required for durability and for safety. However, as a result, these structures cannot be pre-manufactured since they are difficult to ship and install, and difficult or impossible to move and/or reconfigure once installed. For those that are “shippable,” many (if not most) existing ramps and “half pipe” structures require a skilled person for assembly because of the number and complexity of parts. For all of the above reasons, current known products are stationary and are not easily moved and reconfigured, and further are expensive to purchase, install, and rearrange.

Bands, choirs, theatrical performers, and other performers often set up temporary stages and/or platforms to increase their visibility during a performance, and also to position individual members so that they can see their conductor. Classrooms sometimes need staging to allow students to see the teacher/professor. Known stages and platforms are surprisingly complex, heavy, expensive, bulky, and/or difficult to set up. This includes many pre-assembled platforms that breakdown and/or collapse for improved storability. As a result, set up and take down activities require substantial effort. Also, there is often a risk of injury, such as injury to a worker's back while lifting, or injury to a worker's hand during set-up or take-down. Many temporary stages lack flexibility of use since they are constructed to be “one size.” Some temporary stages include multiple sections that do not all have to be set up, but even here the individual sections are either surprisingly complex, heavy, expensive, bulky and/or difficult to set up. Also, usually the “multiple sections” include only three or four such sections, such that they still are not truly flexible enough to allow sizing to a particular sized footprint.

### SUMMARY OF THE PRESENT INVENTION

The present invention includes a series of interconnectable ramps and platforms made from shaped foam blocks, often with a hard surface applied to working surfaces, and further with an exterior coating applied to resist deformation and withstand extreme weather conditions and to provide frictional non-slip use. The ramps and platforms include hook-shaped connectors that securely engage, assisted by weight and/or gravity, but that are easily disconnectable and reconnectable for reconfiguration/rearrangement. A low weight of the ramps and components allows reconfiguration and rearrangement without physical strain, even by younger users.

In one aspect of the present invention, a ramp system for handicapped individuals and person-carrying wheeled devices includes a plurality of interconnectable blocks suitable for supporting an adult person, and includes at least one ramp with an angled upper surface and at least one landing with horizontal upper surface. Each ramp and landing has mating connectors for releasable interconnection so that the angled and horizontal upper surfaces align.

In another aspect of the present invention, a system for supporting one or more adults includes a plurality of interconnectable blocks each suitable for supporting the weight of an adult person. The interconnectable blocks include at least first and second landings with horizontal upper surfaces at different heights. Each landing has mating connectors for releasable interconnection so that the upper surfaces can be anchored together to create an enlarged raised stage on a flat surface.

In another aspect of the present invention, a terrain-forming component is provided for supporting wheeled devices, the wheeled devices being sized to support a human being. The component includes a polymeric block including an angled upper surface, a hard material laminated to the angled upper surface, an edge guard protecting a lead-in portion of the upper surface, and a connector on the block not forming a part of the upper surface.

In another aspect of the present invention, a ramp is provided for a terrain system for wheeled devices, the wheeled devices being sized to support a human being. The ramp includes a foam block including an angled upper surface, an edge guard protecting a lead-in portion of the upper surface, and a connector on the block for connecting to another block. The connector extends horizontally from the foam block and has a vertically-formed hook connector for secure engagement with a matingly-shaped inverted hook connector.

In another aspect of the present invention, a modular system is provided for forming a terrain for wheeled devices, the wheeled devices being sized to support a human being. The system includes a plurality of interconnectable terrain-forming members including at least one ramp-forming member having an angled upper surface, and including at least one platform-forming member having a generally horizontal upper surface with edges matching a height of a highest point on the angled upper surface. The terrain-forming members and platform-forming members include matingly shaped connectors that releasably engage to retain the members together, the members each being at least 2 feet wide and weighing less than about 100 pounds, or more preferably less than 80 pounds.

In another aspect of the present invention, a modular track is provided for forming a terrain for wheeled devices, the wheeled devices being sized to support a human being. The track includes a platform having four sides including first opposing sides and second opposing sides. The first opposing sides include first connectors. Four ramps are positioned on the four sides of the platform, with a first two of the ramps being connected to the first connectors. A lock bar extends between the second opposing sides and connects a second two of the ramps to the platform.

In another aspect of the present invention, a method of providing a rearrangeable terrain includes providing a plurality of ramp and platform components each having a working top surface of at least about 2 feet wide, at least about 1 foot deep, and at least about 6 inches high, each including vertically-facing edge-located connectors for mating releasable engagement with adjacent components, several of the components weighing less than abou 50 pounds. The method further includes configuring and interconnecting the components in different arrangements to provide a variety of different arrangements with different combined working surfaces.

In another aspect of the present invention, a terrain-forming component for supporting persons and wheeled devices, the wheeled devices being sized to support a human being, includes a first polymeric block including an angled upper surface, a hard material laminated to the angled upper surface, an edge guard protecting a lead-in portion of the upper surface, and a first connector on the block not forming a part of the upper surface. The terrain-forming component further includes a second polymeric block with a second connector for releasable connection to the first polymeric block, the second polymeric block having a functional upper surface selected from a group consisting of a flat platform-like surface, a curb-forming surface, a further-inclined upper surface, and a half-pipe-forming upper surface.

In another aspect of the present invention, a method includes steps of rearrangeable interconnectable series of blocks providing a series of blocks with upper surfaces forming ramps and platforms capable of being interconnected in multiple configurations to support an intended recreational and exercising activity such as gymnastics, in-line skating, skateboarding, cycling; and riding of wheeled devices, and disconnecting, rearranging, and then reconnecting the blocks so that the upper surfaces combine to form different contoured courses of varied height and shape.

An object of the present system is to provide a variety of different lightweight components interconnectable to create different terrains, such as for providing a multi-level indoor (or outdoor) terrain or track for wheeled vehicles.

An object of the present system is to utilize lightweight foam blocks, covered on load-bearing surfaces with hardboard and with a durable polyurea coating to provide low weight components of 25 pounds or less that users (even children) can easily rearrange.

An object of the present invention is to provide an interconnection system for the components that is secure yet easily releasable and also flexible for allowing reconnection when rearranged. Preferably, the interconnection system provides stability in all horizontal directions, so that the interconnected components do not unexpectedly become disconnected.

The present design is also believed to be inventive and patentable.

These and other aspects, objects, and features of the present invention will be understood and appreciated by those skilled in the art upon studying the following specification, claims, and appended drawings.

### BRIEF DESCRIPTION OF DRAWINGS

FIGS. 1-2 are perspective and side views of a three-unit arrangement of interconnected blocks, including two ramps and a platform, forming a first terrain system.

FIG. 3 is a perspective view of the ramp in FIG. 1.

FIG. 4 is a side view of the shaped foam block for making the ramp of FIG. 3, FIG. 5 being an enlarged side view of the lead-in portion of the ramp in FIG. 4.

FIG. 6 is a side view of the platform in FIG. 1.

FIG. 7 is a side view of a multi-unit arrangement of interconnected blocks, including ramps, platforms, stacker platforms forming a second terrain system.

FIG. 8 is a side view of a modified center platform with two hard surfaces and configured for inverted use.

FIG. 9 is a side view of a second modified center platform without hard surfaces.

FIG. 10 is a side view of a curb member.

FIG. 11 is a side view of an extended platform.

FIG. 12 is a side view of a half pipe member.

FIG. 13 is a multi-unit arrangement of interconnected blocks, including a half pipe member and a ramp forming a third terrain system.

FIG. 14 is a multi-unit arrangement of interconnected blocks, including a ramp and a curb member forming a fourth terrain system.

FIGS. 15-16 are top and side views of a lock bar connector member.

FIG. 17 is a perspective view of a fifth terrain system with four interconnected ramps, a platform and lock bar members,

FIG. 18 being a cross section taken along the plane XVIII-XVIII in FIG. 17.

FIGS. 19 and 20 are perspective views of a sixth and seventh terrain system of interconnected components.

FIG. 21 is a perspective view of a handicap ramp system, and FIGS. 22-23 are side and top views of the handicap ramp of FIG. 21.

FIG. 24 is a fragmentary perspective view of a flat-turn-around platform block and its railing, and FIG. 25 is a cross section through XXV-XXV in FIG. 24.

FIGS. 26-31 are exploded perspective views of alternative railing attachment systems, and FIG. 32 is an exploded perspective view of a particular rail system.

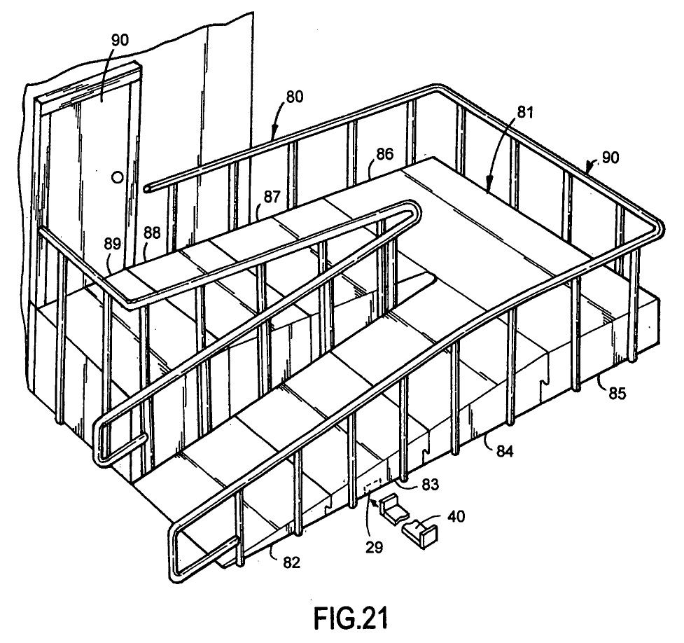

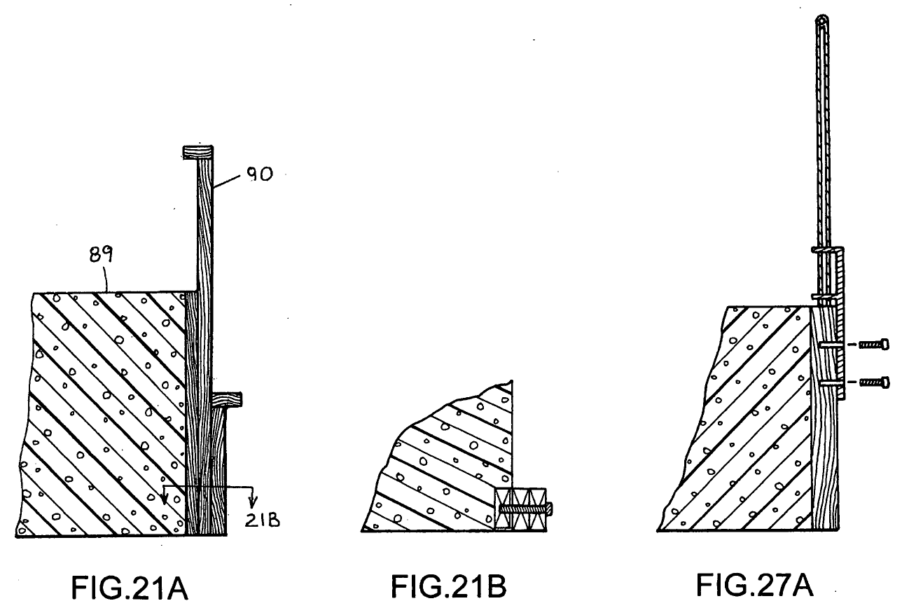

FIGS. 21A, 21B, 27A, 27B, 28A, 30A, 31A, 31B, and 32A are views of alternative brackets, similar to those shown in views 21, 27, 28, 30-32.

FIG. 33 is a side view of the lead-in ramp from FIG. 21 defining an incline of 1″ rise to 12″ run, and FIG. 34 is an enlarged fragmentary view of its leading end.

FIG. 35 is a perspective view of a temporary two-level stage built by a system of the present blocks into a T shape.

FIG. 36 is an exploded perspective view of a single square stage built with four identical blocks and having aesthetically flat sides.

FIG. 37 is a perspective view of a temporary two-level stage built by forming a lower level ring around a higher level center stage portion.

FIG. 38 is a perspective view of a block with hook connectors on opposing sides, where the cut-off piece is used to form a mating hook connector on an adjacent side(s).

FIG. 39 are top views of five different blocks, block A, B, C, and D (the numbers 1-4 indicating different rotational positions) and block A5 being a mirror image of block A.

FIG. 40 is a top view of selected blocks A-D assembled to form a large stage.

FIGS. 41-43 are side views of various blocks forming steps and/or different stage levels, and FIGS. 44-45 are plan views of various block arrangements forming a multi-level choir stage.

### DETAILED DESCRIPTION OF PREFERRED EMBODIMENTS

The present system includes a variety of different components (also called “members”) interconnectable to create different terrains, such as for providing a handicap ramp, or a multi-level indoor (or outdoor) terrain or track for wheeled vehicles, such as multi-wheeled devices including in-line skates, skateboards, bicycles, tricycles, four-wheeled manually-powered cycles, and the like, or a stage/platform for performances. The base material for the illustrated ramps and platforms is lightweight foam, such as 3 pcf (pounds per cubic foot), or more preferably 2 pcf, which if functionally required, can be covered on load-bearing surfaces with hardboard (e.g., about 0.1 inch thickness) and then covered with a durable coating (e.g., polyurea). The results are low weight components that can be readily moved and put in place. Preferably individual blocks weigh about 60 pounds or less, or in some circumstances where children and young adults may want to move the blocks, about 25 pounds or less, thus allowing even younger users to easily rearrange and create new and different terrains and tracks. Where rearrangeability is desired, each block, ramp, and component can be easily moved by manually lifting and placing them to form various configurations, assisted by using built-in hand grips that are designed into the lowermost surface of each ramp or platform. The exterior surfaces of the ramps and platforms are preferably textured to create a frictional engagement that helps maintain a non-slip position of the components on the floor or ground, and that helps create friction with individual's feet and with wheels of the wheeled device, thus allowing good non-slip use and maneuverability. By completely covering the foam blocks with a polymeric coating such as spray-applied polyurea coating, the coating both provides a durable and non-slip coating, and also adds considerable structural strength to the blocks via a tensioned-skin arrangement.

### Rearangeable Ramps and Terrains

The present components (also called “blocks”) are each based on a common dimensional “standard” to facilitate flexible connection and appropriate alignment of heights at exit/edge surfaces. For example, the ramp “A” (FIG. 1) can be wire cut from a foam block 19 to have a bottom surface 21 of about 36 inches×48 inches, an angled working surface 22 extending at about 12-13 degrees, and a maximum height of about 8.25 inches. The ramp “A” can be attached to any number of different blocks/components in different arrangements, such as blocks B, D, E, F, HP shown in FIGS. 1, 2, 7, 13, 14, 19, 20. In one form, the foam is expanded polystyrene (EPS) foam, such as 3 pounds per cubic foot (pcf) (or 2 pcf, or in some circumstances 1-½ pcf or even 1 pcf).

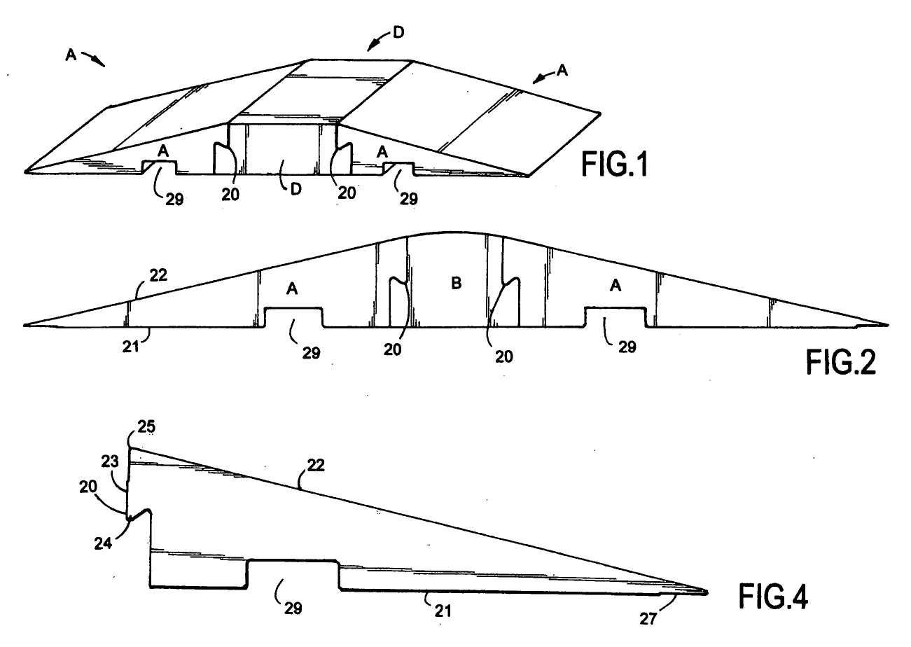

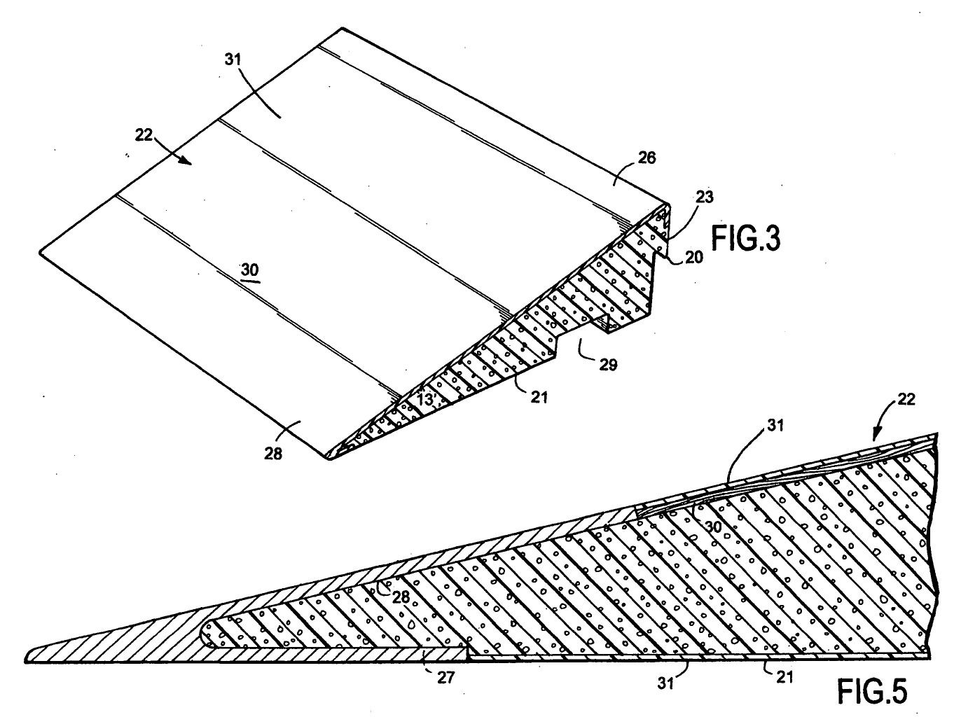

A hook connector 20 is formed in its vertical end surface 23, the connector 20 located at half the height of the end surface 23 and being shaped to releasably engage a similar inverted hook connector on a mating component (see FIG. 2). The hook connector 20 (FIG. 4) includes an angled surface 24 extending at about 35 degrees and which extends about 1-½ to about 2.0 inches into a face of the end surface 23 and has a vertical depth of about ¾ inches. Corners are rounded to eliminate stress-focusing points. This hook connector 20 is shaped somewhat like a “bird beak” and its shape is believed to provide an optimal secure and positive retention force and also to provide good releasability while maintaining a strength of the hook connector 20.

The ramp A can include added support inset into its leading edge for added strength and durability. As illustrated, a recess 25 is formed into a top of the end surface 23 for receiving the shaped bent or extruded metal (aluminum) protector 26 laminated to the recess and around the top corner of the ramp A second recess 27 is cut into the bottom surface 21 at the lead-in tip, for receiving the protector 28 laminated onto the ramp A at the tip. A rectangular notch 29 is cut into the bottom surface 21 about 6 inches away from the end surface 23 and forms a hand grip. Where added surface strength is needed, a hardboard 30 (FIG. 5), such as ⅛ to ¼ inch thick, is laminated onto the angled working surface 22 and extends between the top flanges of the protectors 26 and 28 (FIG. 5). A polymeric polyurea coating 31, such as 0.05 to 0.15 inch thickness, or more preferably about 0.08 to 0.10 inch thick (or even less), is applied to the ramp A, preferably completely enclosing the ramp A to form a durable non-slip surface on all sides. The coating also provides “skin strength” which adds considerable strength to the block since localized stress is distributed to reduce foam breakage, and also since the skin adds to beam/bending strength.

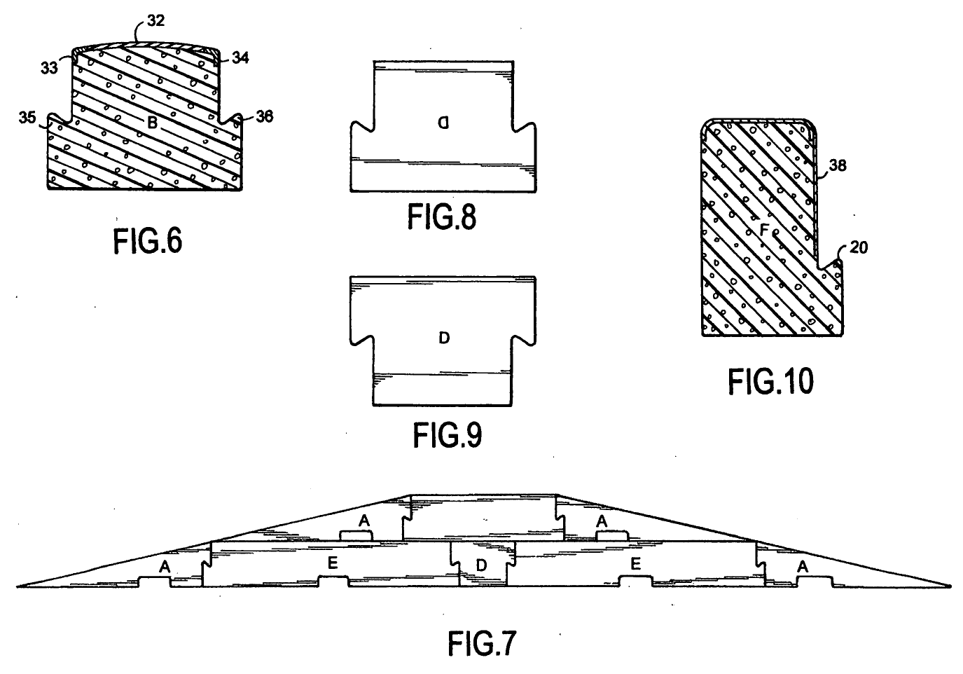

FIG. 6 illustrates center hump-style platform component B, where a top surface includes a hardboard protector 32 with metal edge flanges 33 and 34 that extend downward to better protect top corners of the platform by helping distribute stress. The connectors 35 and 36 are identical (or similar) to the connectors of ramp A.

FIG. 7 illustrates that the components can include extended platforms E (called “double stackers”) to allow double height stacked arrangements. At a center is a short platform D that can be used to interconnect adjacent platforms (see FIG. 7). Notably, the illustrated platform D includes hardboard on its top and bottom surfaces, such that its top surface has hardboard regardless of which orientation it is in. It is contemplated that the platform D can be made short in length or longer, and that it can include 0, 1, 2, or more surfaces with hardboard thereon.

Block “B” (FIGS. 1 and 6) has a rounded top reinforced surface, while block “D”(FIGS. 7-9) has a flat top and bottom surface (which allows it to be inverted).

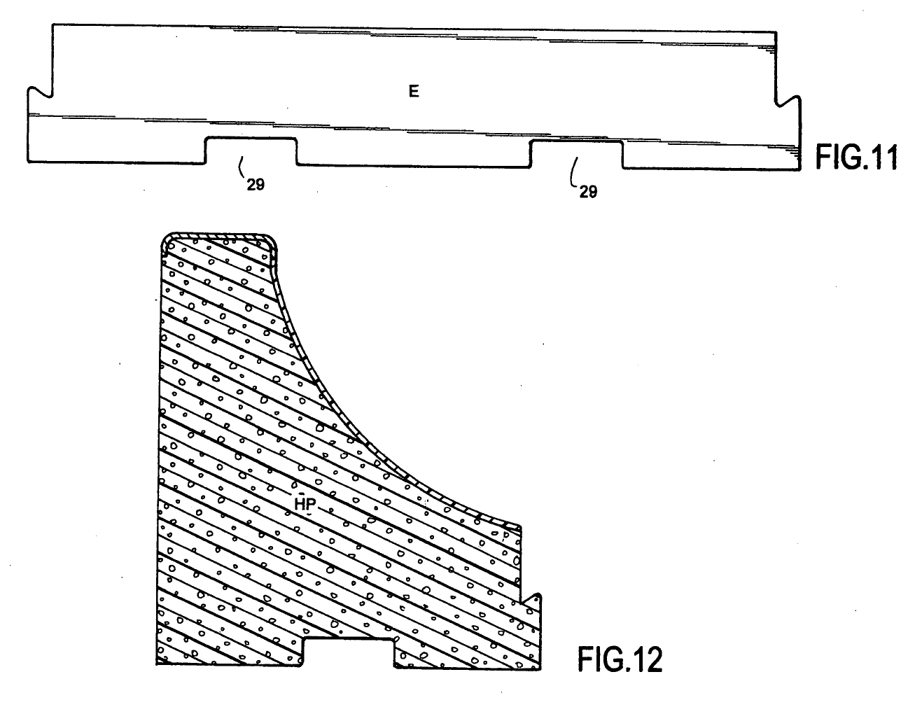

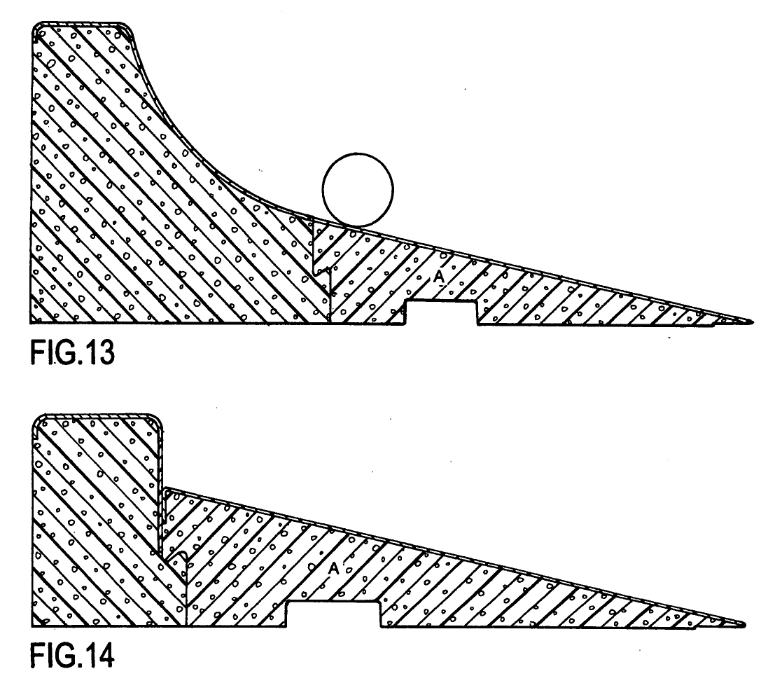

FIGS. 10 and 14 illustrate a curb component F having a shape generally similar to the short platform D, but with only one connector 20 and where its body is extended to a location significantly higher than the typical platform A. For example, the illustrated curb component F has a total height of about 12-¾ inches, which is about 4-½ inches higher than platform A. A protector can be attached to its top surface (such as for supporting skateboarders doing “curb slides”), and also can have a hardboard attached to its side surface 38 (such as where skaters may impact the side surface when racing in a track (see FIG. 19). The half pipe component HP (FIGS. 12-13) includes a circular or curvilinear shaped working surface. It includes laminated protectors and laminated hardboard for protecting (and distributing stress) on working surfaces much like the curb component F.

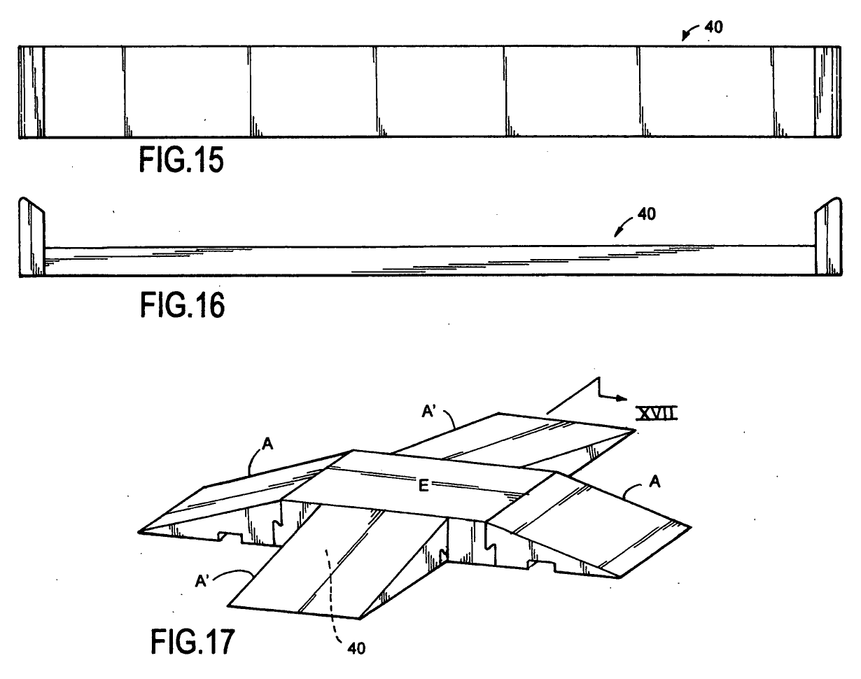

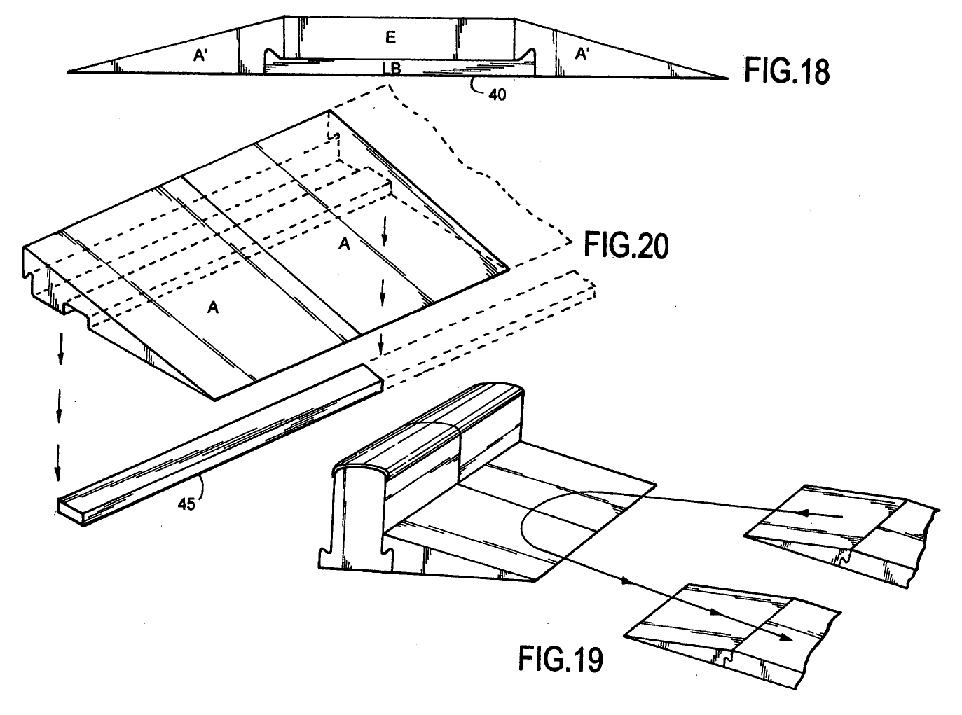

The “dance floor” platform E (FIG. 11) has a bottom surface of 48 inches×48 inches (or similar size) with two rectangular recesses 29 forming hand-holds, and include opposing connectors 20. The flat side surface 39 does not include connectors. However, a pair of lock bar connectors 40 (FIGS. 15-16) can be placed within the recesses 29 to form the equivalent of connectors 20, since the ends of the lock bar connectors 40 are shaped to replicate an upwardly facing one of the connectors 20. The pair of connectors 40 can then be used to securely engage perpendicular ramps A′, holding them securely against the flat sides. (See FIGS. 17-18.) Notably, the ramps A′ are identical in shape to ramps A, with the apostrophe being used only to identify their different orientations.

The present components can be arranged to form a track, such as for racing wheeled devices and/or for forming a circuit for physical training. See FIG. 19 which illustrates a U-shaped portion of such as track. A first assembly (see FIG. 20) includes curb and ramp components for forming an angled surface that assists the user in making a U-shaped turn. A second assembly includes ramp and platform components for providing different elevations as part of the track. It is contemplated that the track can include intersections (see FIG. 17) and/or any of the illustrated arrangements (see FIG. 7) and numerous other arrangements incorporating any of the present components. Also, it is contemplated that additional components can be designed for particular needs and functions and for supporting particular specialized activities. FIG. 20 illustrates an impact bar (similar to the lock bar in FIG. 18). The bar 45 is a multiple side elongated bar that is designed to fit into a identical shape slot that is cut into the bottom surface of the ramp, platform, half pipe or other designed components and is intended to adjoin multiple ramps that are set beside each other in alignment. The bar 45 is of such a length that when installed in the shaped slot on the bottom surfaces and extending to the outermost vertical walls of the ramps, platforms, half pipes or other components, will lock in place these components in such a manner that when a load at right angles or lesser angles to the bar impacts an individual component, all components will remain in alignment with each other.

The present components are lightweight and provide a multitude of possible configurations to increase the enjoyment of a person that wishes to increase the satisfaction of riding a multi-wheeled device such as in-line skates, a skateboard, or multi-wheel cycles.

Using the component of this invention allows the recreational rider the ability to continuously modify and reconfigure the components to create different levels of moderate to difficult configurations for more or less challenging riding and promote a increased benefit healthy life style.

The present system provides for a solution to easily create a modifiable configuration of ramps and platforms for recreational use. The components when not in use can easily be stored in a location that takes up a minimal space. The present invention is coated with a material that prevents damage to the exterior surfaces of the individual components and preserves it against damage from weather conditions such as rain, snow, frost and extreme temperature changes.

In addition, the components have specific design considerations for different degrees of experience by individuals that are just learning or have a higher degree of experience regarding surfaces that are at various levels relative to a singular flat plane. Specifically, the illustrated ramps have angles of 12-13 degrees, such that riders of all levels can easily learn to maneuver up and down the ramps with little or no training. The illustrated ramps include a width of approximately 48 inches which accommodates many styles of multi-wheel devices without fear of falling off the edge. The ramps can be stacked in multiple layers to increase the degree of difficulty for more advanced users.

Regarding rearrangement, the ramps and other components have a relatively low weight, allowing them to be manually moved and reconfigured to increase or decrease the degree of difficulty, even by younger users. The ramps and components can also be manually moved and reconfigured to create a circuit training track for aerobic or circuit training for cardiovascular workout routines. This ability to reconfigure can be used to create different degrees of physical difficulty thus promoting an intended variable cardiovascular activity.

The ramps and components are constructed in such a manner that they will withstand the constant use of wheels across their entire surface, despite high degrees of pressure that potentially will come from wheels contacting their surfaces, the pressure coming from varying degrees of hardness of wheels and different degrees of rider physical weight. The ramps and components are designed in such a manner that built-in hand grips on the lowermost surface will allow an individual, even without experience to easily transport and move various ramps and platforms to new and creative configurations.

An infinite number of different terrains and tracks can be constructed. For example, FIGS. 1-2 illustrate a simple up-ramp, platform, and down-ramp. FIG. 7 illustrates how ramps and components can be stacked to increase the degree of difficulty to move from a horizontal plane to the ground to a higher level and return to the ground level. FIG. 13 illustrates a half pipe arrangement with lead-in ramp. FIG. 14 illustrates how a tapered ramp can be interconnected with an interlocking curb to act as a return for a 180 degree turn with built-in safety curb. FIG. 17 illustrates a 4-way intersection with four lead-in ramps connected to a platform. FIG. 19 illustrates a circuit track where the curb arrangement of FIG. 14 is combined with a ramp arrangement of FIG. 1 to create a U-shaped portion of a continuous track.

FIGS. 3-4 show details of a ramp, including the cut foam block (FIG. 4) prior to attachment of a hardboard to its top wear surface (FIG. 3), and including bent metal angle laminated to its narrow lead-in tip (FIG. 4), a hardboard laminated to its angled wear surface, and a second bent metal angle laminated to its tail for supporting weight at a trailing edge (i.e., over the hook-shaped connected). Notably, in many installations, the cut foam block does not need to have to be cut to receive a bent metal angle at its lead-in tip. FIG. 5 shows a typical lead-in tip end of a ramp where tip strength is particularly important, such as for roller skate and roller blade terrains, which includes a low density foam core (e.g., 3 pcf, or more preferably 2 pcf), a glued hardboard top surface (hardboard thickness such as 0.9 inches), an aluminum leading edge forward located surface, and a hard coat exterior coating of polyurea for a tapered ramp.

Many of the components can be used in different ways. FIG. 8 shows a typical adjoining section that is a universal flat platform with interlocking sections on the vertical walls, and a hardboard surface on the top and bottom horizontal planes such that the part will provide a hard surface useable in either orientation when interlocked to a ramp or platform with corresponding interlocking members. In addition when rotated 180 degrees about a horizontal axis this part designed to interlock with any piece that has the same locking member located equal distance from the top or bottom surface.

The following inventive concepts incorporate a lot of identical and related structure and characteristics that were described above. For simplicity and to reduce redundancy, the description uses similar identical numbers or identical numbers with an additional letter such as “A”, “B,” etc.

### Handicap Ramps

The present system can be used to construct a temporary or semi-permanent (or permanent) handicap ramp, such as for providing ramp access to buildings and structures for wheelchair bound individuals or individuals not able to handle stairs safely. The present system is particularly easy to pre-construct, ship, and assemble/install on site. This can be very important for individuals who need temporary ramps into their residences (such as where they are healing from an injury and temporarily cannot use stairs), and where typical on-site construction is not possible or practical (such as where cost is prohibitive, where the homeowner can't build the ramp and lacks friends or family to help construct it, where lead times for building licenses are too long and/or the ramp is needed immediately, and/or where the ramp is necessary for only a short time such that the time to construct it doesn't justify the project).

It is noted that all of the illustrated foam blocks 82-89 below are intended to be covered with a polyurea coating, (including covering of the inset supports, e.g., supports 100, 100A, 100B, etc.). However, in the FIGS., the inset supports are often/sometimes shown in solid lines (instead of hidden/dashed lines) for clarity.

An exemplary handicap ramp system 80 (FIG. 21) includes an assembled ramp 81 (FIGS. 22-23) constructed of releasably interconnected blocks 82-89 (each block being wire cut from an EPS foam block and covered with a polyurea coating 31) and a railing 90 forming a hand rail around ends and sides of the ramp system 80. The blocks 82-84 form a first incline, blocks 85-86 form a flat/level turn-around landing, blocks 87-88, 88′ form a second elevated ramp, and block 89 forms a top flat/level landing area with the entrance 91 (i.e., the building door). Notably, the maximum rise to run is 1:12, and the maximum rise for any given run is 30 inches, and further landings must typically be at least 5 feet by 5 feet (and for turn-arounds, at least 5 feet by 8 feet). The ramp 81 can be set on an appropriately prepared surface, such as on concrete or other hard surface or on compacted sand smoothed over for receiving the ramp 81. The system 80 can be anchored to a building by brackets or by staking that prevents the ramp system 80 from slowly shifting/moving away from the building.

Notably, the present ramp system 80 is very adaptable and flexible in design and use. For example, the present ramp system can be used inside or outside, and can even be constructed to fit over existing steps and ground surface deformities. Further, the illustrated ramp system includes two inclines connected by a single turn-around and a (relatively) short flat top landing, but it is contemplated that a ramp system could be constructed with longer runs, additional inclines, additional (or larger) turn-arounds, and a larger top landing area. There are also requirements for hand rails on both sides if a ramp has a rise greater than 6 inches, or a horizontal run greater than 72 inches, which can easily be met using the present concepts. Edge protection can be provided to prevent people and wheelchairs from slipping off the system, such as by including curbs of 2 inch height along appropriate edges, or by attaching low-height barriers attached to posts of the railings. The polyurea coating can be applied as a rough non-slip covering and as such is believed to be sufficient, but it is noted that additional surface finishes, colors, paints, sand-grit strips and the like can be added, if desired.

In a preferred form, each ramp has an expanded polystyrene (EPS) foam core that is hot wire cut to a specific size and slope. The density of the EPS is preferably in a range of about 1.0 to 3.0 pcf (pounds per cubic foot), or more preferably about 1.5-2.5 pcf, or most preferably about 2.0-2.5 pcf. Computer generated profiles can be used to assure that each part will be identical from order to order. Around each illustrated EPS core there are vertical slots wire cut to accept treated 2×4 structural (wood) members (or 2×6 wood board). The 2×4 support members are placed in channels in the foam blocks (i.e., the supports are “imbedded”) around the sides of each sloped piece and around the sides and ends of each landing block. The top surface, where desired, can be laminated to a hardboard, and if desired, covered with all weather carpet for outdoor use or with a Formica product if for indoor use. Alternatively, it is noted that a hardboard surface with polyurea completely encasing it with a skid resistant texture can be attached atop the block/ramps.

The complete blocks (with inset 2×4 structural member) are sprayed with a polyurea coating on the bottom and all vertical surfaces to seal it from moisture and dirt. This also adds considerable strength to the block, both by distributing localized stress and also by holding the foam block together with a shrink-wrap-like action that increases surface durability and structural integrity of the block and that forms a surface-tensioned arrangement with substantially increased structural (beam) strength.

Where aesthetics allow it, channels 29 can be formed in bottoms of the blocks, such as for providing a hand hold and for receiving lock bars 40. Other features can be added if necessary, such as to facilitate attachment of particular railing systems, or the like.

It is contemplated that the blocks 82-89 can be any width, but it is contemplated that they will be sufficient in width to provide room for a wheelchair and for a railing . . . and to meet any local, state, federal, or insurance regulation or requirement. For example, the illustrated blocks 82-89 are slightly more than about 36 inches to 42 inches wide, and about 48 inches long. (Notably, many laws relating to handicap ramps require a 36″ clear span width for the wheelchair-supporting surface.) The illustrated largest block 89 can weigh about 100-120 pounds, but preferably is kept to less than about 60 pounds, depending on a density of the foam used, a thickness of the coating, and whether a reinforcing plywood board or metal extrusion is used on its top surface or leading edge. The blocks also can be constructed to support an appropriate weight or wheeled device. It is contemplated that illustrated blocks 82-89 can be 2 to 2.2 pcf EPS, and even 1-½ pcf, depending on weight requirements, length of expected use, location of use, the likelihood of abuse, and other considerations. It is contemplated that the block will be coated with polyurea coating to about 0.08 to 0.10 inch thickness and that typically a hardboard undersheet will not be required. (See hardboard 30, FIG. 5.)

The blocks 82-89 can be constructed similar to blocks A, D, E discussed above in FIGS. 1 and 7. Further, in many circumstances, the blocks 82-89 may be produced without a hardboard to form its top surface. Instead, with wheelchair ramps, it has been found that the blocks 82-89 can be formed sufficiently solid and durable by completely covering an EPS foam block with a durable outer coating 91, where the coating adds surface durability as well as distributes localized stress to reduce or eliminate “crumbling” of the foam at corners and to reduce or eliminate “grooving” on its other surfaces from to localized focused stress. In a preferred form, the polyurea coating is at most about 0.120 inches maximum thickness, and more preferably 0.100 inches thick on its upper and lower surfaces, and potentially slightly less on other surfaces, such as about 0.080-0.090 inches thick. Polyurea coatings are known and can be bonded to EPS provide a durable surface that does not release from the foam over time. Polyurea coatings can be applied to form a rough non-slip surface, but that does not tend to retain water and other outdoor elements, such that they are good for forming a non-slip walk-on and roll-on surface for people and wheelchairs. Further, this surface works well in the area of the hook connectors 20, providing a tight, stable, and secure attachment, but which can be caused to release upon intentional effort.

The illustrated ramp 81 (FIG. 23) includes a 1 inch rise per 12 inch run, which is somewhat less than the ramp “A” disclosed above in FIG. 1, such that the lead-in ramp 82 (FIG. 34) is quite thin and requires a reinforced leading tip to reduce breakage and for durability. The illustrated ramp 82 (FIG. 33) includes a tip 95 covered with an aluminum extrusion tip-reinforcing member 96 (or other metal or structural member) that can handle the focused stresses occurred when a wheelchair initially runs onto the ramp tip 95. The tip-reinforcing member 96 includes ridges and/or a rough upper surface to facility non-slip entry, and may or may not be covered with the polyurea coating. At least a remainder of the angled upper surface of the ramp block 82 is covered with the polyurea coating. This angled upper surface may also include a reinforcing layer, such as a ½ inch thick hardboard piece 30 and/or a Formica layer or a sheet metal or a composite layer. A total thickness of the coating and (if present) reinforcing layer is sufficient so that the upper outer surface of the tip-reinforcing member defines a continuous angled plane. The blocks 82-89 (FIGS. 22-23) include up-facing and down-facing hook connectors 20 configured to releasably frictionally engage as previously described for mating secure interconnection. They also include bottom notches 29 creating hand-holds to facilitate handling and placement. These notches 29 are configured to receive lock bars 40 that can be used to attach the blocks 82-85 to adjacent blocks 86-89.

The blocks 82-89 are particularly constructed to stably support railing 90. The posts of the railings can be integrally embedded into the blocks 9with an upper end extending upward 2 to 3 feet) or the entire railing (and posts) can be secured to the side of blocks, such as by attachment to embedded supports 100.

For example, block 85 (FIGS. 24-25) includes several vertical channels 99 along selected sides, the channels extending the sides of the respective block where railing may be needed. Attachment support members 100, such as a 2×4 (2 inch by 4 inch) wood stud (or 2×6) are frictionally fit into (“inset into”) respective channels. The support members 100 can be adhered in place if desired. The illustrated support members 100 have pre-assembled bolts having a threaded end 101 extending outward. When the polyurea coating is applied, the attachment support members 100 are fixed securely to the block 85, and form a surprisingly and unexpectedly strong structural unit with the blocks. Notably, the channels and support members can extend horizontally along edges of the blocks if desired. For example, see block 85A and support member 100A.

The illustrated railing 90 (FIG. 21-21B) includes posts that attach (such as by using lag bolts or other threaded attachment) to an outside of the inset support members 100. The illustrated railing 90 includes a top railing that is continuous along both sides of the angled and landing portions of the handicap ramp system, and that begins 12 inches in front of a start of the first inclined ramp 82, and that closes the outboard end of the upper landing block 89. It is contemplated that the hand rails for the lower and upper inclined ramp portions can be mounted on a single set of posts (see FIG. 25) (instead of doubled-up posts as shown in FIG. 21A-21B).

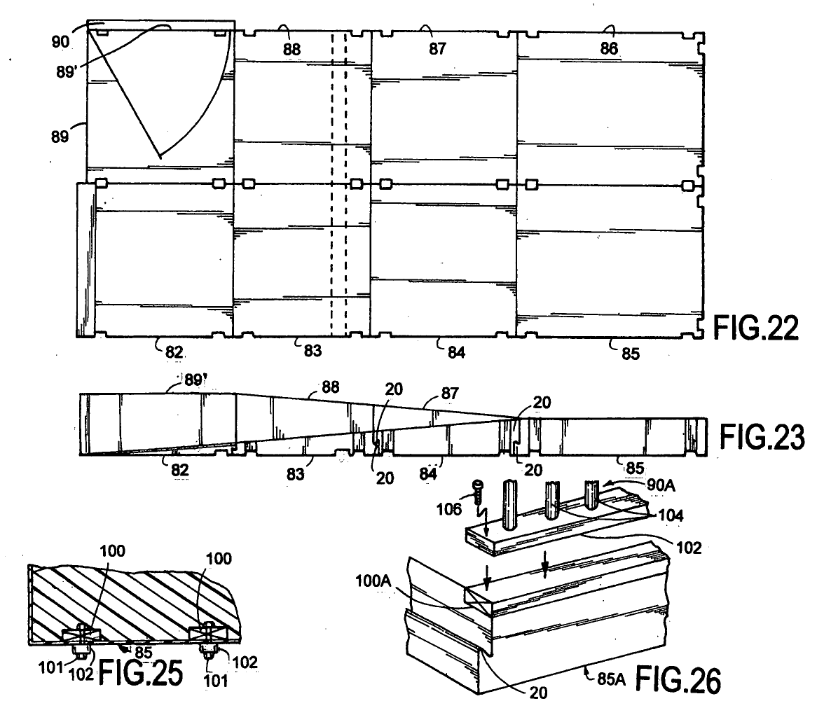

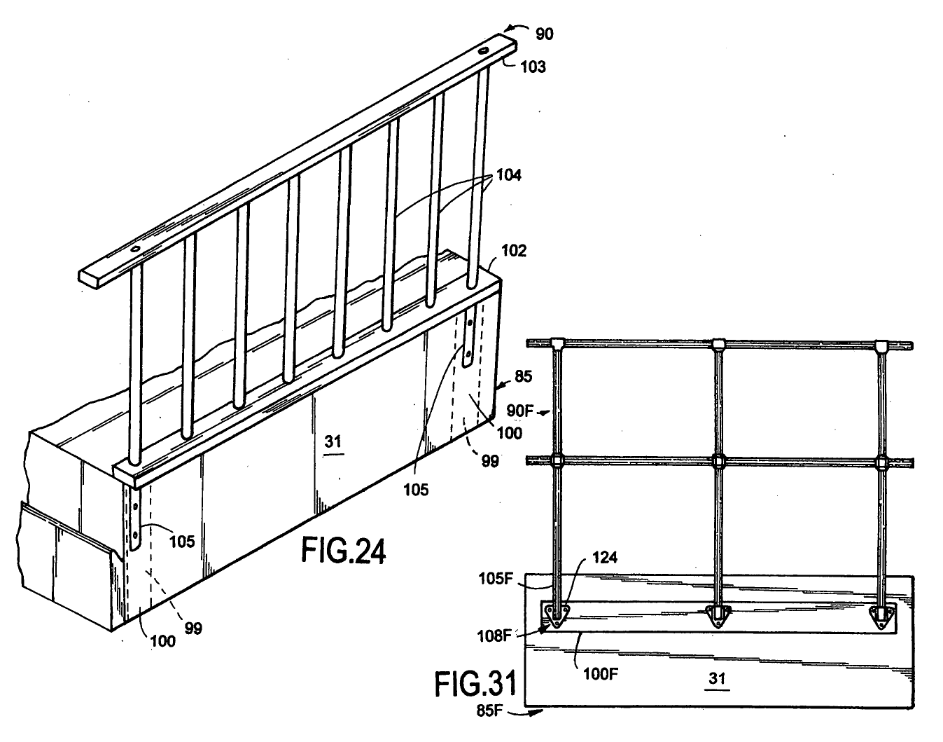

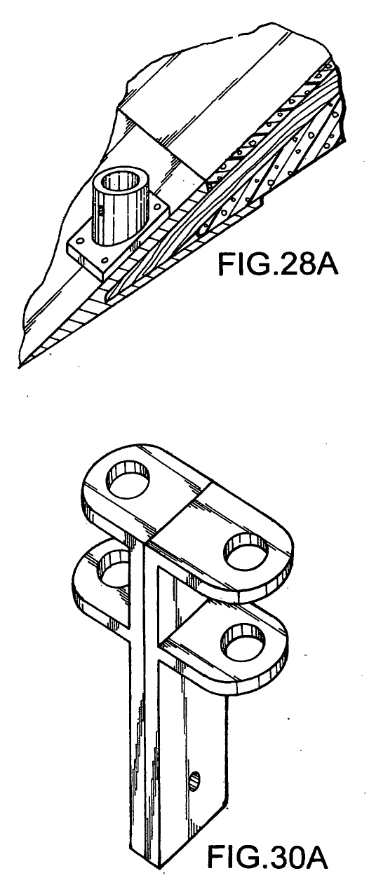

It is contemplated that a variety of different railing support systems and railing systems are possible. FIGS. 26-31B are exploded perspective views of exemplary alternative railing attachment systems, and FIGS. 32-32A are exploded perspective views of particular rail systems. For example, the attachment support member 100A (FIG. 26) is a 2×6 that extends horizontally along an edge of the block 85A. The railing 90A (FIGS. 24 and 26) is similar to railing 90, but in railing 90A, the vertical studs 104 do not extend through the lower horizontal stud 102. The lower stud 102 of railing 90A extends parallel, lies on, and is supported by the attachment support member 100A. Sufficient fasteners 106 (such as lag bolts) are used to secure the railing 90A in place. Notably, the sections of the railing typically are joined at (or extend around) one or more corners (see FIG. 21), such that part of their stability and strength against tipping sideways comes in part from adjacent sections of the railing 90A.

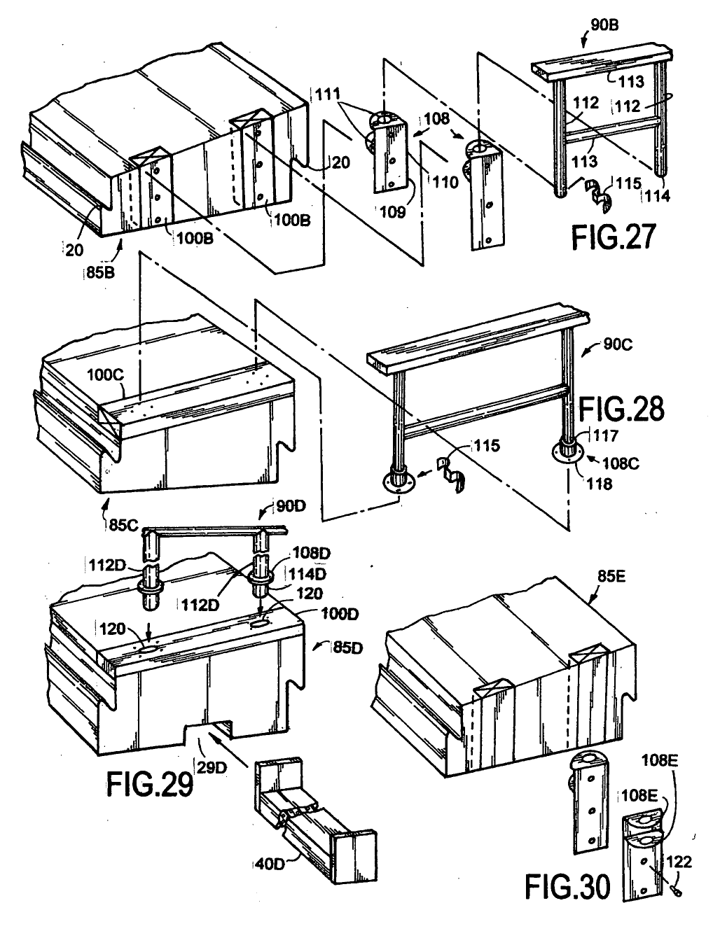

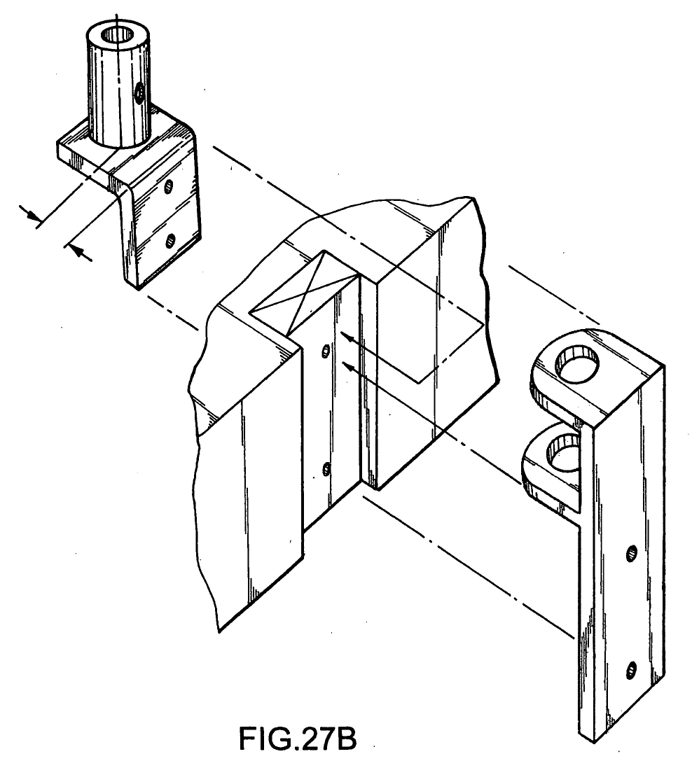

FIGS. 27-31 show a variety of different rail-supporting attachment schemes that can be constructed. For example, FIG. 27 shows a block 85B having vertical attachment support members 100B, and brackets 108 for supporting a railing 90B made of pipes and a flat hand rail. The brackets 108 are metal and include a lower leg 109 with holes for attachment to a side of the vertical attachment support members 100B, and include an upper leg 110 with lateral flanges having vertically-aligned holes 111. The railing 90B includes interconnected vertical pipes 112 and horizontal pipe(s) 113. A lower end 114 of the pipes 112 can be extended into the vertically-aligned holes 111. In a center of the ramp system (i.e. between the low ramp portion and the high ramp portion), clamps 115 can be used to positively secure the posts on the lower railing 90B to the posts on the upper railing. It is contemplated that the clamps 115 can also be used to secure adjacent vertical pipes 112 together (such as vertical pipes 112 on adjacent blocks 84 and 87), thus helping to hold blocks of the ramp 81 together. FIG. 27A shows a side view of the bracket attachment for the posts of FIG. 27. FIG. 27B shows two alternative brackets, where the support member 100B is inset into the foam blocks to create an outwardly facing recess. A lower leg of the brackets attach to the support member 110B, each having a thickness sufficient to create a flush outer surface after attachment.

FIG. 28 illustrates a block 85C with a horizontal support member 100C. The railing 90C includes a pipe railing assembly similar to FIG. 27, but in FIG. 28 the bracket 108C includes a first tube section 117 for receiving a lower end of the vertical pipes (posts) in the railing 90C and an annular flange 118 with apertures for screw-attachment to a top of the horizontal support member 100C. Clamps 115 can be used. FIG. 28A includes an alternative style bracket with an upwardly-extending tube section for receiving a lower end of the vertical pipes in railing 90C.

FIG. 29 illustrates a block 85D with a horizontal support member 100D. In block 85D, holes 120 are drilled vertically through the horizontal support member 100D into the block 85D. The railing 90D is similar to railing 90A in that some of the vertical pipe sections 112D include a lower end 114D can be extended into the vertically-aligned holes 120. Brackets 108D are similar to brackets 108C, but in FIG. 29 they are slid upward onto the vertical pipe sections 112D so that a tube section 114D extends below the brackets 108D for engagement with the holes 120. Notably, FIG. 29 also shows a block 85D with down channel 29D for use of a lock bar 40D.

FIG. 30 shows a block 85E similar to that shown in FIG. 27. Two opposing brackets 108E (similar to brackets 108 disclosed above) are bolted together at a location where they are adjacent and extend above the associated block 82-89. Notably, it is contemplated that a screw or bolt 122 could be extended through a first bracket 108E (such as on a block 83) into a second bracket 108E (such as on a block 88), with the end of the bolt 122 extending threadably into the bracket 108E on the second block (88). This allows the blocks (83 and 88) to be secured together at a location below the upper surface of the largest block (88), at a location where the bolt 122 is not readily visible and yet where the bolt 122 is not likely to be accidentally struck or uncomfortably grabbed by a person using the ramp. FIG. 30A illustrates an alternative bracket, including a single down leg and oppositely facing apertured flanges for receiving a lower end of the posts of the railing.

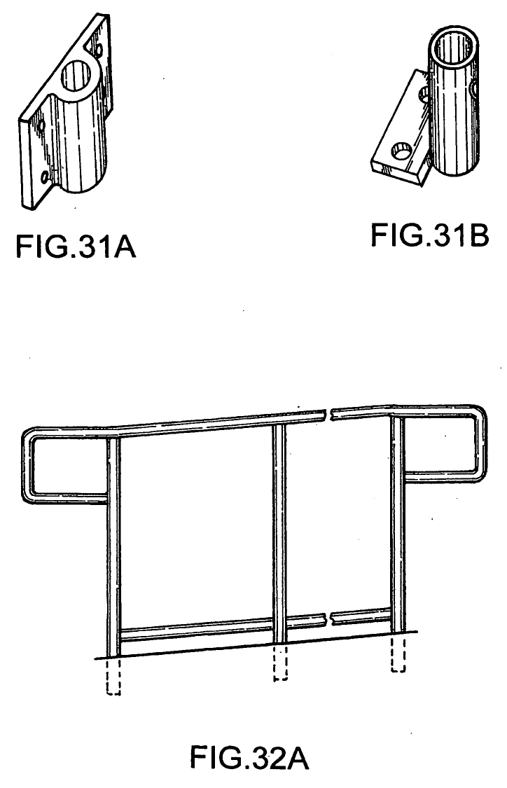

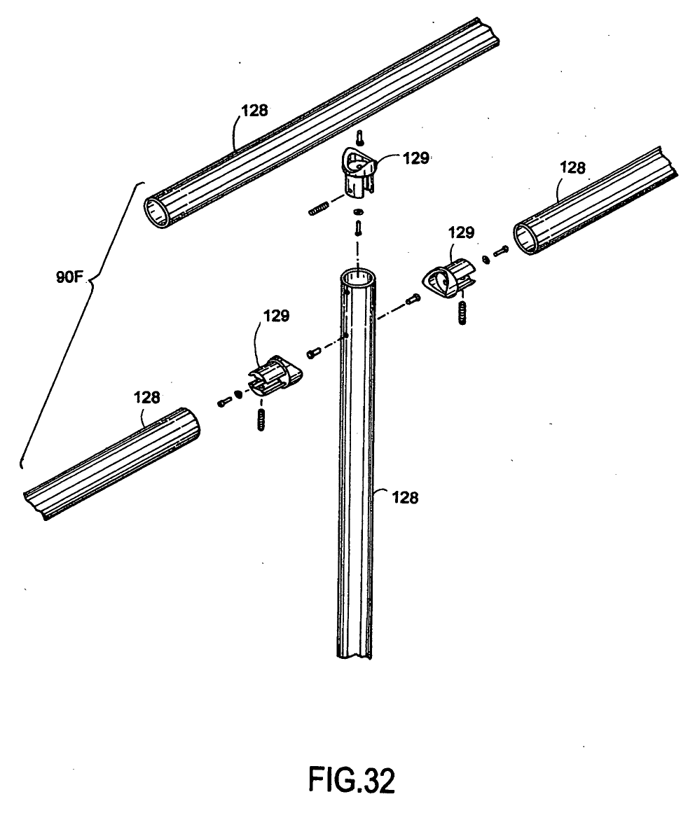

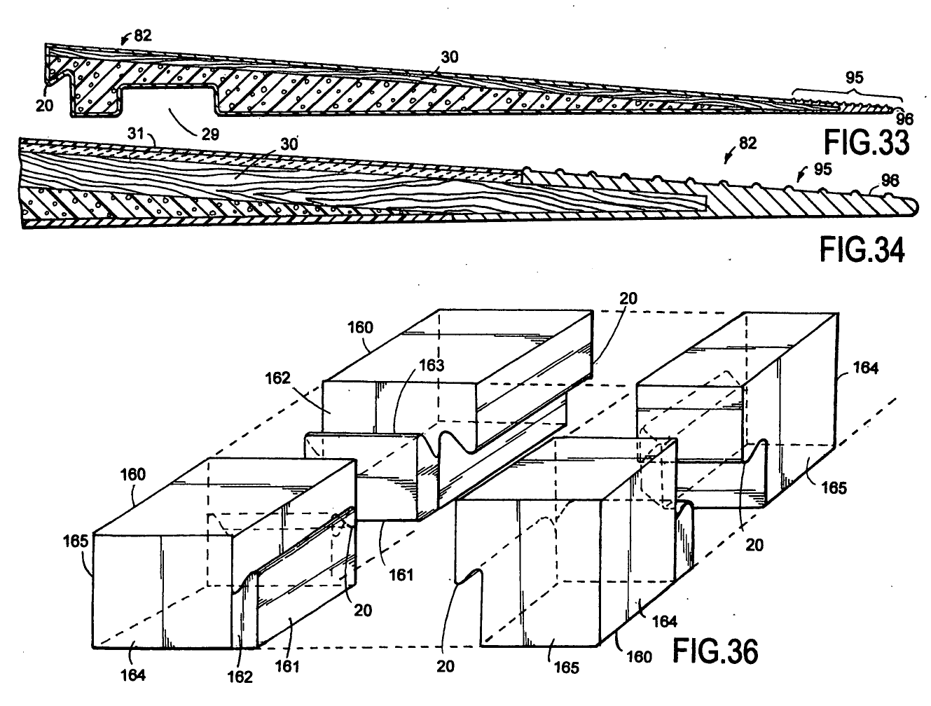

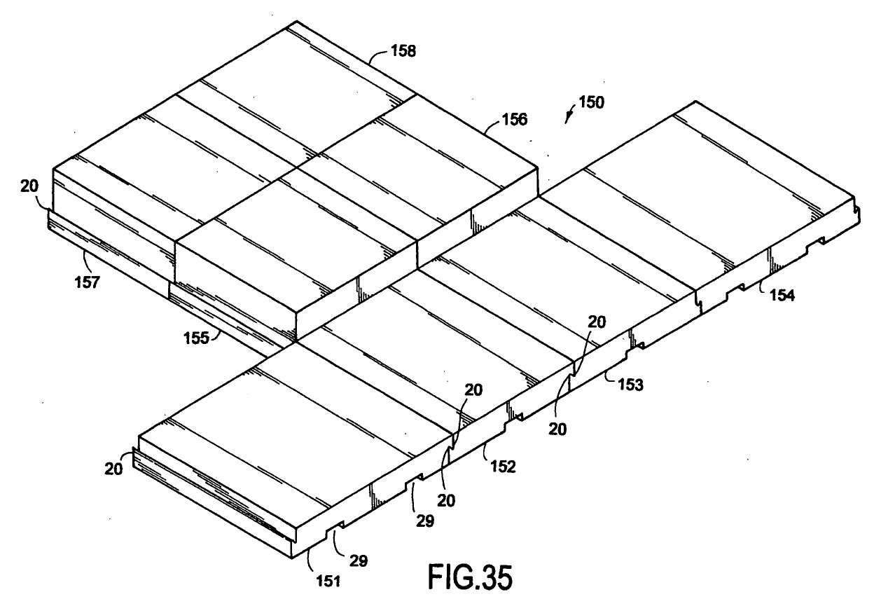

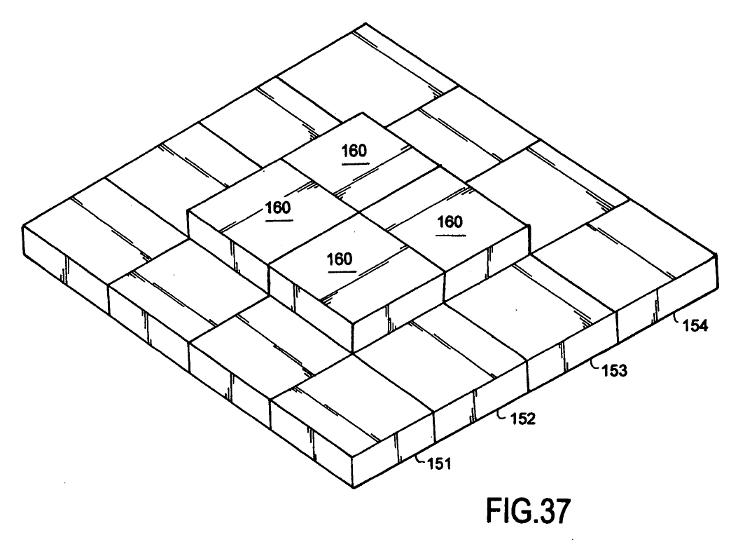

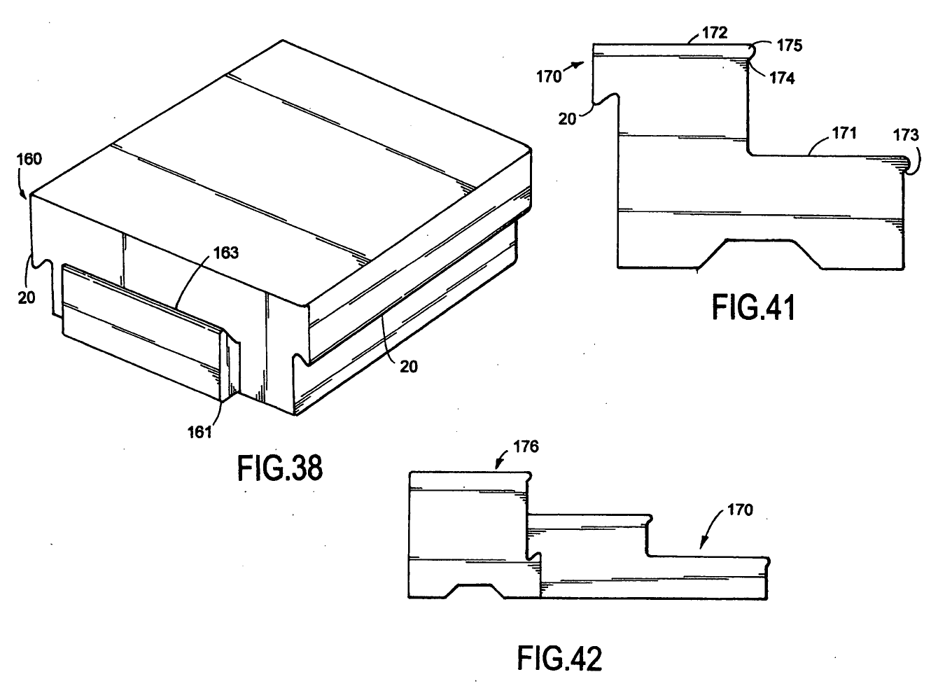

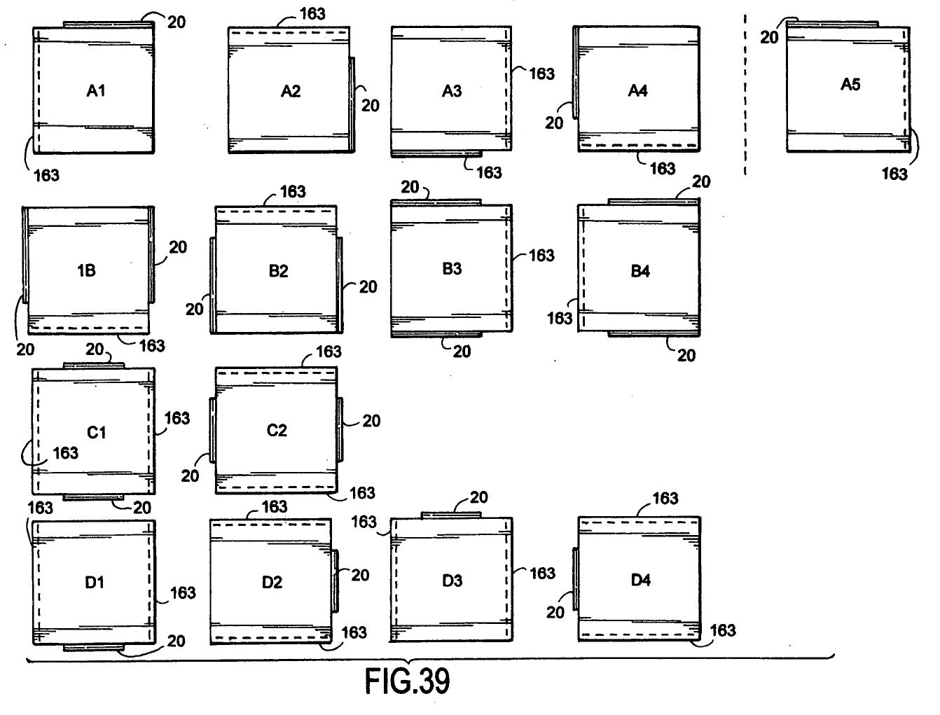

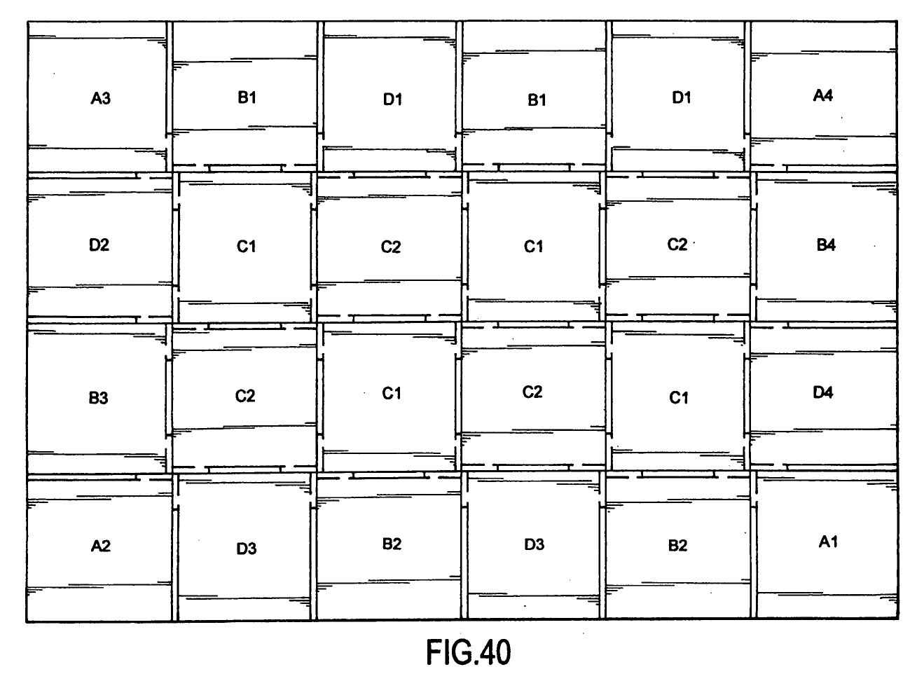

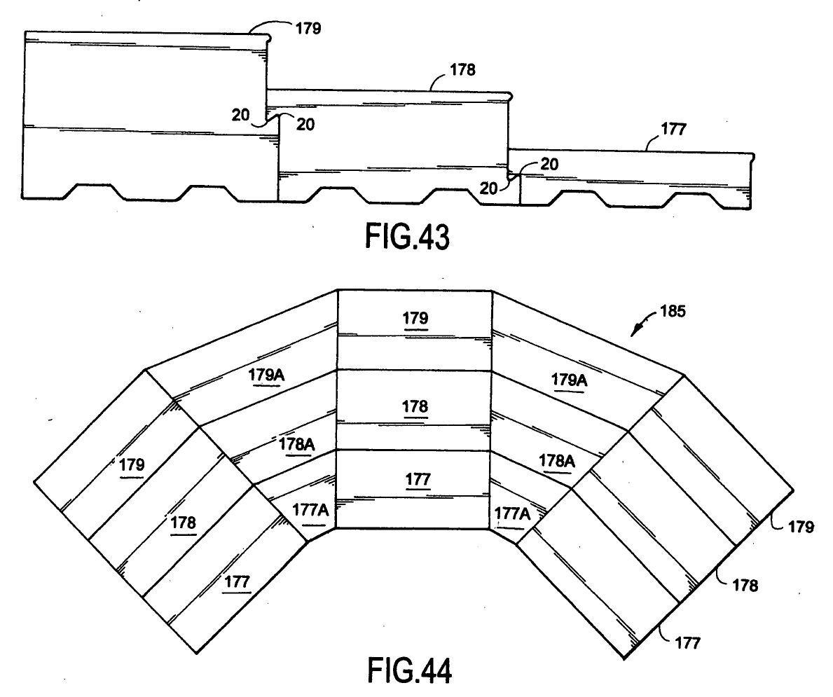

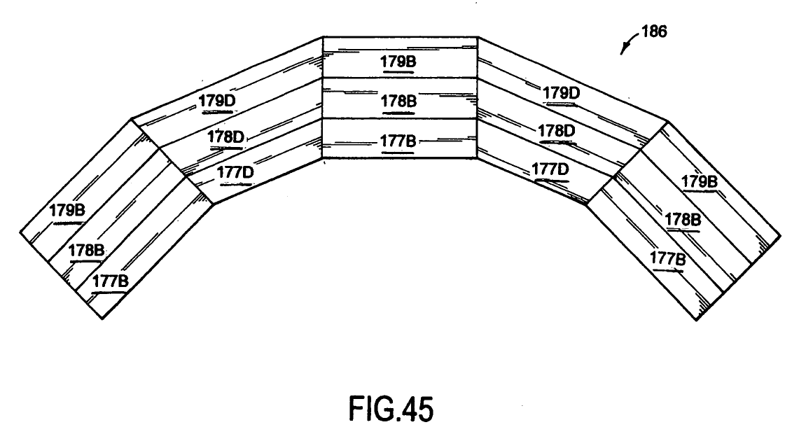

FIG. 31 illustrates a block 85F with a horizontal support member 100F, and a railing 90F attached to sides of the support member 100F. The horizontal support member 100F is, for example, a 2×6 wood stud, with its 6 inch wide surface facing outwardly. As in all the above illustrations, a polyurea coating 31 is applied. A side-facing bracket 108F is attached to a lower leg 105F of several (or all) of the vertical studs (pipes) on the railing 90F. The bracket 108F includes a vertical flange 124 with holes for receiving screws to fasten the brackets 108F to the support member 100F. The illustrated horizontal support member 100F is at a top edge of the block 85F. It is contemplated that a second horizontal support member 100F could be positioned along a bottom edge of the block 85F, such that an additional bracket 108F on each leg could be attached to the second lower support member 100F to provide additional stability to the railing system if necessary or desirable. FIG. 31A shows an alternative bracket similar to bracket 108F. FIG. 31B shows a bracket similar to bracket of FIG. 28A, such as for use on the ramp 82 which has a small vertical dimension (and hence limited ability to generate torsional strength to support the handrail at its leading end).

There are a number of different railing systems available in commerce, and it is contemplated that the present ramp system can be made to accommodate many (if not most) of them. The illustrated railing 90F is one such system. As shown in FIG. 32, it includes a plurality of tubes (pipe sections) 128 interconnected by joining brackets 129, the brackets 129 each having one end that frictionally securely engages an internal end portion of the tubes and another portion for stably engaging a transverse mating tube. (These can also be attached by gluing.) Screws threadably engage the brackets 129 and/or the pipes and/or rivet nuts in the pipes to fix the engagement. The railing shown in FIG. 32A is similar to that of FIG. 32, but it partially pre-welded/pre-constructed.

### Stages and Platforms

The present inventive system with foam blocks can be used to make stands and stages, such as for bands, choirs, theatrical performances, classrooms, and other performance situations where temporary (or semi-permanent or permanent) stages and/or platforms are needed to increase visibility during a performance, and/or to position individual members so that they can see their conductor/instructor. The present stage and platform systems are surprisingly non-complex in their construction and assembly, and are relatively lightweight yet sturdy and solid in their construction. Further, they can accommodate bumps, irregularities, and small stones in a floor/ground support surface while maintaining stability on the support surface (e.g., by the foam yielding to create a pocket for the stone or irregularity, or by placing a bottom cutout 29 on the stone or irregularity). A variety of different stages and platforms can be made that breakdown for dense storage, and that can be assembled in a variety of different ways to satisfy different needs (even while using a same set of building blocks). As a result, set-up and take-down activities require much less effort than prior known systems. Also, risk of injury is reduced, since weight is less, hand-holds are provided, and the blocks are of a type that results in less pinch points and less tendency to cause injury. Notably, it is contemplated that the stands and stages will not require ramps, handrails, and/or hardboard upper surfaces . . . but of course these can be provided if desired.

A temporary two-level stage 150 (FIG. 35) is built by a system of foam blocks 151-158 that can be assembled into a T-shaped stage, with blocks 151-154 forming a lower (front) height and blocks 155-158 forming a higher (rear) height. The illustrated blocks 151-158 are made of EPS foam having a density of 2 to 3 pcf, coated with a polyurea coating, and include several features discussed above such as the hook connectors 20 and the hand-holds 29. The blocks 151-158 form level surfaces that can be walked on without fear of tripping, and their upper surface is preferably a polyurea coating so that it is non-slip (even when damp) so that this stage 150 can be used inside a building or outside a building. Specifically, the polyurea coating allows the stage 150 to be used inside such as on quality gym floors, wood floors, and hard-surfaced floors where it is important to not scratch or damage the surface, and also allows them to be used outdoors such on pavement, concrete, asphalt, flat dirt, and the like where small undulations are often present and where moisture, sun, high and low temperature, and other outside weather and elements may be encountered. Lock bars can be used to secure the blocks 151-154 and 155-158 (i.e., the blocks forming the upper and lower levels) together . . . and to secure the two levels together. Alternatively, connectors 20 can be placed on adjacent blocks 152 and 155 and also on block 153 and 156 for mating interconnection.

FIG. 36 is an exploded perspective view of four identical blocks 160, which can be interconnected to form a single square (solid) stage built with aesthetically flat top and sides. Each block 160 includes a hook connector 20 on one side. The original EPS foam block from which the block 160 is constructed has a piece 161 cut-off to form the down-facing hook connector 20. (See FIG. 38.) That cut-off piece 161 is attached to an adjacent side 162 to form an up-facing second hook connector 163 that can be mated to the connector 20, such as by adhering and/or mechanically-attaching the cut-off piece 161 to the adjacent side 162. The illustrated second connector 163 extends a full width of its side wall for maximum strength. However, it is contemplated that it may be shortened sufficiently to allow ease of engagement without loss of strength when assemblying the blocks that engage the opposing locking members (20) in two different directions such as a final block that forms a square.

It is contemplated that an outer end surface of the connector 163 will be flush with the outer wall of its block 160, so that when assembled, the stage has an aesthetic flat outer continuous surface. Also, an inner end of the connector 163 terminates short of the connector 20 so that the connector 163 does not interfere with operation of the connector 20. Notably, the outer side surfaces 164-165 are flat, such that when assembled, the four blocks 160 form a stage with all four of its sides being flat planar surfaces that are aesthetically pleasing. Also, it is noted that the polyurea coating will be provided that entirely covers each block and that has a very attractive appearance, such that the entire stage is essentially a combination of EPS foam blocks with polyurea coating. It is also noted that the blocks 160 can be made in different sizes, such that the resulting stage can be a desired total size and desired height.

FIG. 37 is a perspective view of a temporary two-level stage built by forming a lower level ring around a higher level center stage portion. It is contemplated that the stage can be made in different ways. For example, the center stage portion can be made of blocks 160, and a separate ring can be made of additional blocks similar to the front blocks 151-154 shown in FIG. 35 around the center-positioned blocks 160. It will be apparent that the blocks of the outer perimeter can be made with hook connectors that are either exposed or hidden.

A variety of different blocks can be made for interconnection by using the principle shown in FIG. 38. As noted and shown above, in FIG. 38, the block 160 has a piece 161 cut-off one side to form the down-facing hook connector 20, which cut-off piece 161 is attached to an adjacent side 162 to form an up-facing second hook connector 163 that can be mated to the connector 20. The cut-off piece 161 can be secured such as by adhering and/or mechanically-attaching the cut-off piece 161 to the adjacent side 162. The illustrated cut-off piece 161 is slightly shorter than a full width of each block so that it does not interfere with the hook connector on an adjacent side. In the illustrated block A1, the end of the cut-off piece 161 is spaced slightly from the side having the hook connector 20. The block 160 in FIG. 38 also has a second connector 20 formed on a side opposite the first connector 20.

FIG. 39 illustrates five different types of blocks A, B, C, and D, with the numbers 1-4 being used to indicate different rotational positions of blocks. All blocks have a same basic “floor-forming” size and a floor-engaging footprint. The blocks A1-D4 can be selectively interconnected/assembled to form a stage with a flat vertical perimeter surface (i.e., where the exterior surface of the assembled stage does not include an exposed hook connectors), as discussed below.

The blocks A1-D4 are constructed as follows. The block A1 has a single up-facing hook connector 20 on its left side as shown, and a down-facing second hook connector 163 made by attaching the cut-off piece to an adjacent side positioned clockwise from side with the hook connector 163. Block A2 is identical to block A1, except rotated clockwise 90 degrees. Blocks A3 and A4 are identical to block A12, except rotated clockwise 180 degrees and 270 degrees, respectively. (Block A5 is very similar to block A1 but is a mirror image of block A1. Block A5 is needed for some platforms, such as a platform made 5 blocks deep and 6 blocks wide.) Block B1 has two up-facing connectors 20 on opposite sides, and a single down-facing connector 163 on a side between them. Blocks B2-B4 are identical blocks but at 90 degree clockwise rotated positions, respectively. Block C1 has hook connectors 20 on opposite sides, and mating hook connectors 163 on the other opposite sides. As a result, there is only one rotated position (i.e., block C2), since if block C1 was rotated 180 degrees, it is the same as original block C1. Block D1 is similar to block B1, but block D1 has two down-facing connectors 163 on opposite sides, and a single up-facing connector 20 on a side between them. Blocks D2-D4 are identical blocks but at 90 degree clock-wise rotated positions, respectively.

FIG. 40 is a top view of selected blocks A-D assembled in a 4-block-deep and 6-block-wide arrangement to form a large stage. Where the blocks are about 4 feet×4 feet, the stage area is about 16 feet deep by 24 feet wide. Notably, the blocks shift and settle to adjust to slightly uneven floors and uneven supporting surfaces. One of the advantages of the present stage is that it is very stable, with people walking on it and standing on it feeling steady and well-supported. Also, the present stage is particularly quiet and non-resonant. This is optimal for bands, choirs and situations where sounds can bounce back and cause problems for performers as well as creating a poor listening situation. For example, hollow cavities under a stage are known to cause undesired reverberations not unlike a drum-like “booming” sound simply from footsteps on the platform. The present platform system of blocks totally eliminates this resonance problem. Also, the present block includes a foam interior and polyurea skin covering that can deform to accommodate a stone or irregularity in a floor support surface while still providing a stable stage surface.

FIGS. 41-43 are side views of various blocks forming steps and/or different stage levels, and FIGS. 44-45 are plan views of various block arrangements forming multi-level choir stages. Specifically, block 170 (FIG. 41) includes a hook connector 20 on one side, and further includes first and second surfaces 171 and 172 forming two steps. The undercuts 173 and 174 are at a front edge of the surfaces 171 and 172 and combine to form overhang lips 175 on the surfaces 171 and 172 to provide a more traditional step with less tendency to cause someone to trip, since it allows the toe of a person to slip forward closer to the next step surface. Notably, the block 170 can be attached to a side or rear of a particular platform system. FIG. 42 illustrates a step system formed by block 170 combined with a second block 176 for forming three step system. FIG. 43 illustrates three blocks 177-179 attached together to form a three tier riser system. Each block 177-179 includes a hook connector 20 for attachment to the next block (with block 178 including front and rear connectors 20), and the front riser block 177 includes a front overhang lip 175 as previously described.

A U-shaped, multi-level stage 185 (FIG. 44) is constructed of blocks, where several blocks 177-179 have a constant width, and where other blocks 177A-179A have a trapezoid shape so that, when connected, the stage forms a U-shape around a conductor area. The stage 186 (FIG. 45) is similar to stage 185, but stage 186 includes blocks 177B-179B are wider than blocks 177-179, and where blocks 177D-179D are wider than blocks 177A-179A. Notably, some of these blocks can weigh 100-120 pounds, but most are less.

It is to be understood that variations and modifications can be made on the aforementioned structure without departing from the concepts of the present invention, and further it is to be understood that such concepts are intended to be covered by the following claims unless these claims by their language expressly state otherwise.

1. A ramp system for handicapped individuals and person-carrying wheeled devices comprising:
a plurality of interconnectable blocks suitable for supporting an adult person and including at least one ramp with an angled upper surface and at least one landing with horizontal upper surface, each ramp and landing having mating connectors for releasable interconnection so that the angled and horizontal upper surfaces align.

2. The ramp defined in claim 1, wherein the blocks each include internal material filling a majority of space below the upper surface and a lower surface of the associated blocks.

3. The ramp defined in claim 1, wherein the blocks comprise a block of solid foam.

4. The ramp defined in claim 3, wherein the foam comprises expanded polystyrene foam.

5. The ramp defined in claim 3, wherein each block is covered with a durable polymer coating.

6. The ramp defined in claim 5, wherein the coating comprises polyurea.

7. The ramp defined in claim 3, wherein the foam is a low density foam of less than about 3 pounds per cubic foot.

8. The ramp defined in claim 7, wherein the foam is less than about 2 pounds per cubic foot.

9. The ramp defined in claim 1, wherein at least the upper surface of each block includes a friction-generating coating.

10. The ramp defined in claim 1, wherein at least the upper surface of at least one ramp includes a textured portion.

11. The ramp defined in claim 1, wherein all working surfaces of each block are entirely covered with a coating of polyurea of about 0.050 inches to 0.150 inches.

12. The ramp defined in claim 1, wherein the mating connectors are hook-shaped.

13. The ramp defined in claim 12, wherein the hook-shaped connectors include an angled surface forming part of an engagement lip.

14. The ramp defined in claim 1, wherein the mating connectors are integrally formed in the blocks.

15. The ramp defined in claim 1, wherein each of the at least one ramp and at least one landing weighs less than about 80 pounds.

16. The ramp defined in claim 1, wherein at least some of the ramp weighs less than 35 pounds.

17. The ramp defined in claim 1, wherein at least one of the ramps weighs less than 20 pounds and has an angled surface of at least 2 feet×2 feet.

18. The ramp defined in claim 1, wherein at least one ramp is at least about 3 feet wide, and is 3 inches to 12 inches high at a highest end.

19. The ramp defined in claim 1, wherein each ramp has a rise to run of at most 1:12.

20. The ramp defined in claim 1, including a railing and brackets for attaching posts of the railing to one or more of the blocks.

21. The ramp defined in claim 1, wherein at least some of the blocks include a hole for receiving an end of a post forming part of a railing.

22. The ramp defined in claim 1, wherein at least some of the blocks include an inset structural member with a portion adjacent an edge of the associated block, the structural member strengthening the edge and providing structure for attachment.

23. The ramp defined in claim 1, wherein the blocks, when interconnected, form a handicap ramp for wheelchairs.

24. The ramp defined in claim 23, wherein the blocks, when interconnected, form a double ramp with switch-back landing area.

25. The ramp defined in claim 1, wherein at least one of the ramps includes a metal wedge-shaped member that fits onto a leading edge of the one ramp to strengthen the leading edge.

26. A system for supporting one or more adults, comprising:
a plurality of interconnectable blocks each suitable for supporting the weight of an adult person, the interconnectable blocks including at least first and second landings with horizontal upper surfaces at different heights, each landing having mating connectors for releasable interconnection so that the upper surfaces can be anchored together to create an enlarged raised stage on a flat surface.

27. The system defined in claim 26, including ramps interconnected with the interconnectable blocks and forming an inclined surface extending from the horizontal upper surfaces.
